(19) United States
(12) Patent Application Publication
(10) Pub. No.: US 2016/0190693 A1
(43) Pub. Date: Jun. 30, 2016

(54) HYBRID-TYPE NFC ANTENNA AND THE ELECTRONIC DEVICE THEREOF

(71) Applicant: MediaTek Inc., Hsin-Chu (TW)

(72) Inventor: Shun-Te WU, Hsinchu County (TW)

(21) Appl. No.: 14/977,746

(22) Filed: Dec. 22, 2015

Related U.S. Application Data
(60) Provisional application No. 62/098,496, filed on Dec. 31, 2014.

(51) Int. Cl. H01Q 7/00; H04B 5/00; H04B 1/3827

(52) U.S. Cl. CPC H01Q 7/00; H04B 1/3827; H04B 5/0075

(57) ABSTRACT

A hybrid-type near field communication (NFC) antenna utilized in an electronic device is provided. The hybrid-type NFC antenna includes two differential connection ports and a loop antenna device. The two differential connection ports are respectively coupled to two differential outputs of a radio frequency circuit of the electronic device. The loop antenna device is connected between the two differential connection ports, wherein the loop antenna device includes at least one first metal component, and an inductance of the loop antenna device is greater than a first inductance; and wherein the at least one first metal component is a metal element or an antenna device of the electronic device.

CROSS REFERENCE TO RELATED APPLICATION

The present application is based on, and claims priority from, U.S. Application No. 62/098,496, filed on Dec. 31, 2014, the invention of which is hereby incorporated by reference herein in its entirety.

### TECHNICAL FIELD

The disclosure relates to a hybrid-type NFC antenna, and more particularly to the hybrid-type near field communication (NFC) antenna comprising a part of the metal elements or antenna devices of an electronic device.

### BACKGROUND

NFC stands for Near Field Communications and goes by the acronym NFC. NFC is simply a set of standards for smartphones and similar devices to establish communication with each other by bringing them into close proximity (typically 0-5 centimeters). This set of standards is just like 802.11b or 802.11n for WIFI—it sets the protocols to send and receive information. The application of NFC include swiped proximity payments (such as google wallet for paying at Starbucks), information exchange at small distances (for instance, touching smartphones to share contact information), and simplified setup of devices such as Wi-Fi or Bluetooth. Communication is also possible between an NFC device and an unpowered NFC chip, called a tag (such as an RFID tag).

### SUMMARY

An embodiment of the present disclosure provides a hybrid-type NFC antenna utilized in an electronic device. The hybrid-type NFC antenna comprises two differential connection ports and a loop antenna device. The two differential connection ports are respectively coupled to two differential outputs of a radio frequency circuit of the electronic device. The loop antenna device is connected between the two differential connection ports, wherein the loop antenna device comprises at least one first metal component and an inductance of the loop antenna device is greater than a first inductance; and wherein the at least one first metal component is a metal element or an antenna device of the electronic device.

An embodiment of the present disclosure pro vides an electronic device. The electronic device comprises a radio frequency circuit, and a hybrid-type NFC antenna. The hybrid-type NFC antenna comprises two differential connection ports and a loop antenna device. The two differential connection ports are respectively coupled to two differential outputs of the radio frequency circuit. The loop antenna device is connected between the two differential connection ports, wherein the loop antenna device comprises at least one first metal component and an inductance of the loop antenna device is greater than a first inductance; and wherein the at least one first metal component is a metal element or an antenna device of the electronic device.

### BRIEF DESCRIPTION OF THE DRAWINGS

The present disclosure can be more fully understood by reading the subsequent detailed description and examples with references made to the accompanying drawings, wherein:

FIG. 1 shows a schematic diagram of an electronic device 10 according to a first embodiment of the present disclosure.

FIG. 2 shows a schematic diagram of the hybrid-type NFC antenna 12 according to a second embodiment of the present disclosure.

FIG. 3 shows an exemplary example of the hybrid-type NFC antenna 12 according to a third embodiment of the present disclosure.

FIG. 4 shows an exemplary example of the hybrid-type NFC antenna 12 according to a fourth embodiment of the present disclosure.

FIG. 5 shows an exemplary example of the hybrid-type NFC antenna 12 according to a fifth embodiment of the present disclosure.

### DETAILED DESCRIPTION

The following description is of the best-contemplated mode of earning out the present disclosure. This description is made for the purpose of illustrating the general principles of the present disclosure and should not be taken in a limiting sense. The scope of the present disclosure is best determined by reference to the appended claims.

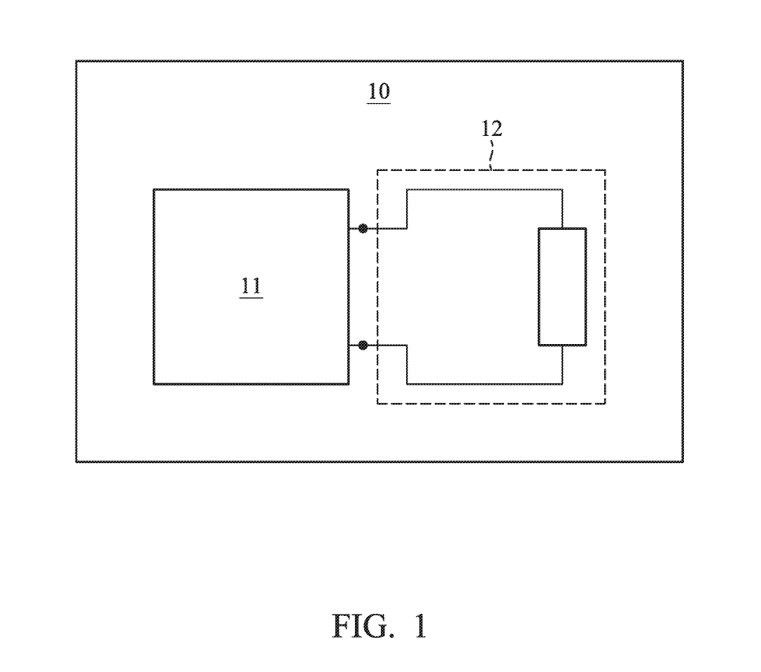

FIG. 1 shows a schematic diagram of an electronic device 10 according to a first embodiment of the present disclosure. In the first embodiment, the electronic device 10 comprises a radio frequency circuit 11, and a hybrid-type NFC antenna. 12. The radio frequency circuit 11 is electrically connected to the hybrid-type NFC antenna 12 for receiving and transmitting signals of near field communication.

In the first embodiment, the electronic device 10 can be a portable device, a wearable device, a digital home product, or an internet of things (IOT) device such as a mobile phone, a tablet, a notebook, a watch, a module, a dongle, a TV, a PC, a speakerphone, an earphone, a headphone, etc.

In the first embodiment, the radio frequency circuit 11 has two differential outputs for connecting the hybrid-type NFC antenna 12, and the radio frequency circuit 11 can be implemented by printed circuit board (PCB) module, chip on board (COB), flexible printed circuit (FPC) module, etc. In the first embodiment, the hybrid-type NFC antenna 12 is a differential-ended NFC antenna.

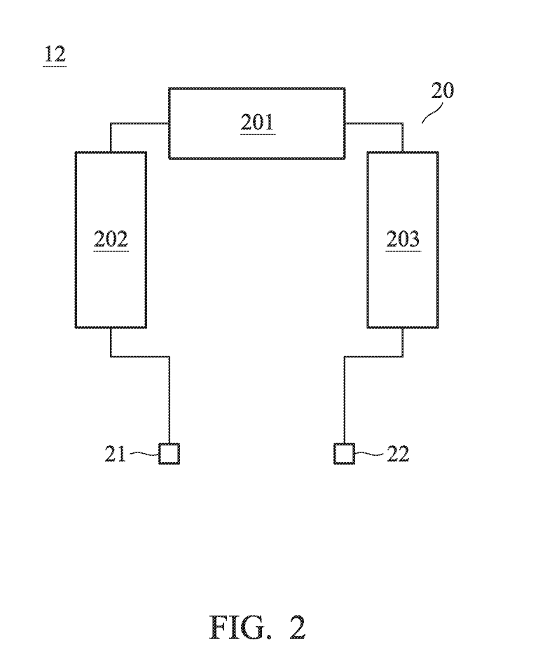

FIG. 2 shows a schematic diagram of the hybrid-type NFC antenna 12 according to a second embodiment of the present disclosure. In the second embodiment, the hybrid-type NFC antenna 12 comprises two differential connection ports 21, 22 and a loop antenna device 20. The two differential connection ports 21, 22 are respectively electrically connected to the two differential outputs of the radio frequency circuit 11 of the electronic device 10. The loop antenna device 20 is connected between the two differential connection ports 21, 22. In the second embodiment, the loop antenna device 20 comprises at least one first metal component 201, and the inductance of the loop antenna device 20 is greater than a first inductance L₁. For example, the first inductance L₁ is equal to 0.15 μH, but the present invention is not limited thereto.

In the second embodiment, the two differential connection ports 21, 22 can be implemented by inductors or short elements, wherein the inductors can be implemented by wire-wound, multi-layer, ceramic chip, low temperature co-fired ceramic (LTCC), etc. The short elements can be implemented by 0 ohm component, metal wire, PCB trace, FPC trace, metal piece, etc. In the second embodiment, the two differential connection ports 21, 22 can also be implemented inside the radio frequency circuit 11 or integrated in the hybrid-type NFC antenna 12.

In the second embodiment, the first metal component 201 is a part of the metal structures of the electronic device 10. In the second embodiment, the first metal component 201 can be implemented by any shape of metal elements of the electronic device 10 such as a conductive housing element, a display shielding metal, a metal foil, an electroplating conductive material, a PCB metal, an FPC metal, a slip, or a slot.

In the second embodiment, the first metal component 201 can also be implemented by far field type antennas of the electronic device 10 such as a loop antenna, planar inverse F antenna (PIFA), inverse F antenna (IFA), patch antenna, monopole antenna, dipole antenna, helical antenna, meander line antenna, slot antenna, strip antenna, etc. The far field type antennas can be made of ceramic chip, metal piece, LTCC, FPC, PCB, metal wire, etc.

In the second embodiment, the first metal component 201 can also be implemented by near field type antennas of the electronic device 10 such as loop antenna, helical antenna, etc. The near field type antennas can be made of metal wire, FPC, PCB, ferrite chip, LTCC, ferrite sheet, etc.

In the second embodiment, the first metal component 201 can also be implemented by inductors such as wire-wound, multi-layer, ceramic chip, LTCC, ferrite sheet, etc. In the second embodiment, the first metal component 201 can also be implemented by 2D or 3D structure of the electronic device 10.

In the second embodiment, the loop antenna device 20 further comprises a first conductive path 202 and a second conductive path 203. The first conductive path 202 is connected between one of the two differential connection ports (i.e., the differential connection port 21) and the first metal component 201, and the second conductive path 203 is connected between the other one of the two differential connection ports (i.e., the differential connection port 22) and the first metal component 201. In the second embodiment, the connected method of connecting the differential connection port 21 (or the differential connection port 22) and the first metal component 201 can be implemented by screw, conductive housing, PCB or FPC traces, pogo pins, antenna terminals, soldering, conductive material or traces, etc.

In the second embodiment, the first conductive path 202 can be implemented by screw, conductive housing, PCB or FPC traces, pogo pins, antenna terminals, soldering, conductive material or traces, etc. of the electronic device 10. In the second embodiment, the second conductive path 203 can also be implemented by screw, conductive housing, PCB or FPC traces, pogo pins, antenna terminals, soldering, conductive material or traces, etc. of the electronic device 10, too. In addition, the first conductive path 202 or the second conductive path 203 can also be implemented by any metal component or structure used in the first metal component 201 such as 2D or 3D structure.

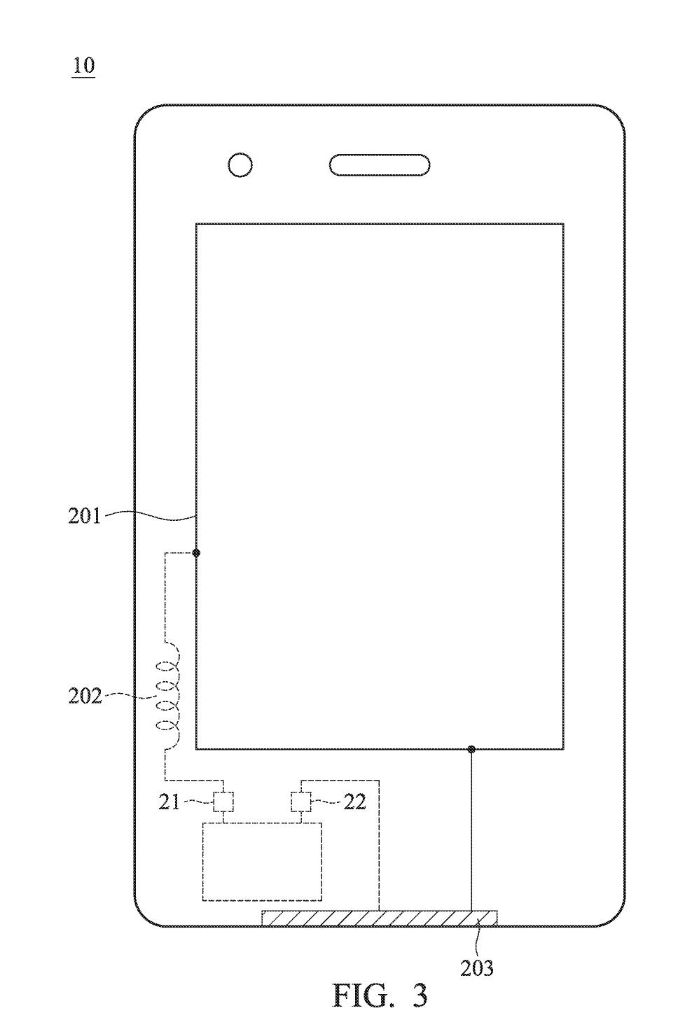

FIG. 3 shows an exemplary example of the hybrid-type NFC antenna 12 according to a third embodiment of the present disclosure. In the third embodiment, the electronic device 10 is a portable device such as a mobile phone. In the third embodiment, the first metal component 201 of the loop antenna device 20 of the hybrid-type NFC antenna 12 is implemented by a LCD metal frame of the mobile phone, the first conductive path 202 of the hybrid-type NFC antenna 12 is implemented by an inductor of the mobile phone, and the second conductive path 203 is implemented by a metal front housing element of the mobile phone.

In the third embodiment, the equivalent serial inductance of the LCD metal frame, the inductor, and the metal front housing element (i.e., the equivalent inductance between the two differential connection ports 21 and 22) is greater than 0.15 μH. Because the hybrid-type NFC antenna 12 of the third embodiment utilizes the present metal components or metal structures of the mobile phone, the additional space cost of the hybrid-type NFC antenna 12 can be thereby reduced.

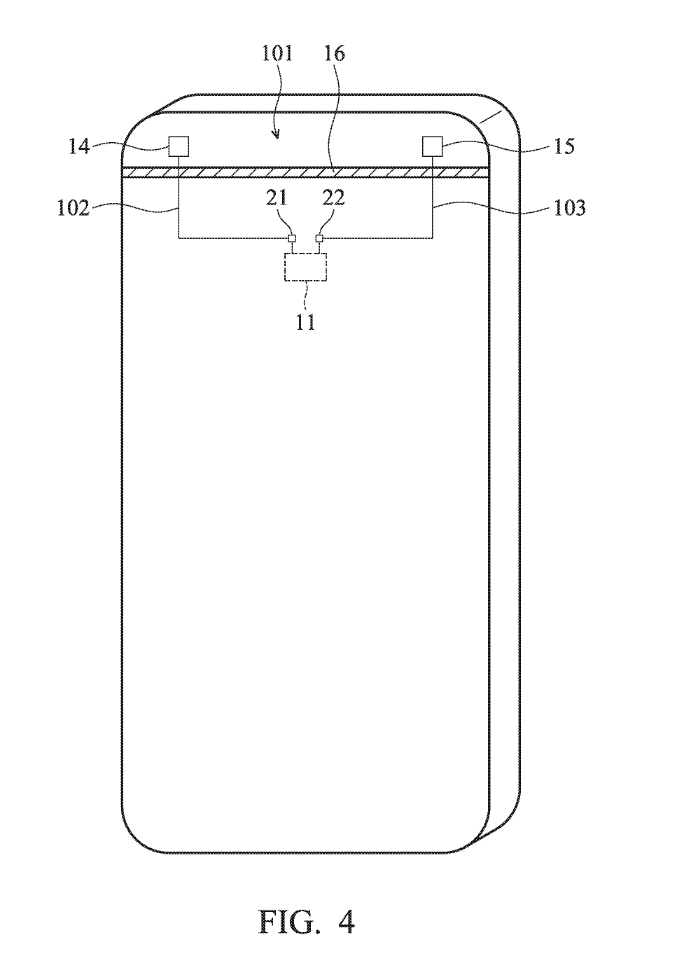

FIG. 4 shows an exemplary example of the hybrid-type NFC antenna 12 according to a fourth embodiment of the present disclosure. In the fourth embodiment, FIG. 4 shows a rear perspective view of the electronic device 10, wherein the electronic device 10 is a portable device such as a mobile phone. In the fourth embodiment, the radio frequency circuit 11 is integrated on a circuit board 13 (not shown) of the mobile phone, and two differential outputs of the radio frequency circuit 11 of the mobile phone are respectively electrically connected to two differential connection ports 21, 22 of the hybrid-type NFC antenna 12.

In the fourth embodiment, the first metal component 201 of the loop antenna device 20 is implemented by a first up-metal back cover 101. In addition, as shown in FIG. 4, the first up-metal back cover 101 is adjacent to a first groove 16 of the mobile phone and form an area with conductive path 202 and 203 to overlap the first groove 16.

In the fourth embodiment, the first conductive path 202 of the loop antenna device 20 is implemented by a first pogo pin 14 which is contacted with first up-metal back cover 101 at left side and a first conductive trace 102, and the second conductive path 203 of the loop antenna device 20 is implemented by a second pogo pin 15 which is contacted with first up-metal back cover 101 at right side and a second conductive trace 103.

In the fourth embodiment, the first conductive trace 102 is arranged from the differential connection port 21 to the first pogo pin 14, wherein the first conductive trace 102 is arranged to route via PCB trace from the differential connection port 21 to a lower node of the first pogo pin 14.

In the fourth embodiment, the second conductive trace 103 is arranged from the differential connection port 22 to the second pogo pin 15, wherein the second conductive trace 103 is arranged to route via PCB trace from the differential connection port 22 to a lower node of the second pogo pin 15. Because the first conductive trace 102 and the second conductive trace 103 are respectively and electrically connected to the lower nodes of the first pogo pin 14 and the second pogo pin 15, the first conductive path 202 of the loop antenna device 20 is coplanar to the second conductive path 203 of the loop antenna device. Accordingly, the first up-metal back cover 101 of the first metal component 201 of the loop antenna device 20 is not coplanar to the first conductive path 202 or the second conductive path 203 of the loop antenna device 20 due to connecting to the upper nodes of the first pogo pin 14 and the second pogo pin 15.

In the fourth embodiment, the inductance of the loop antenna device 20 (i.e., the equivalent serial inductance of the first up-metal back cover 101, the first conductive trace 102, the second conductive trace 103, the first pogo pin 14, the second pogo pin 15 and on board series inductors or short elements) is greater than 0.15 μH, but the present invention is not limited thereto. Because the hybrid-type NFC antenna 12 of the fourth embodiment utilizes the present metal components or metal structures of the mobile phone, the additional space cost of the hybrid-type NFC antenna 12 can be thereby reduced.

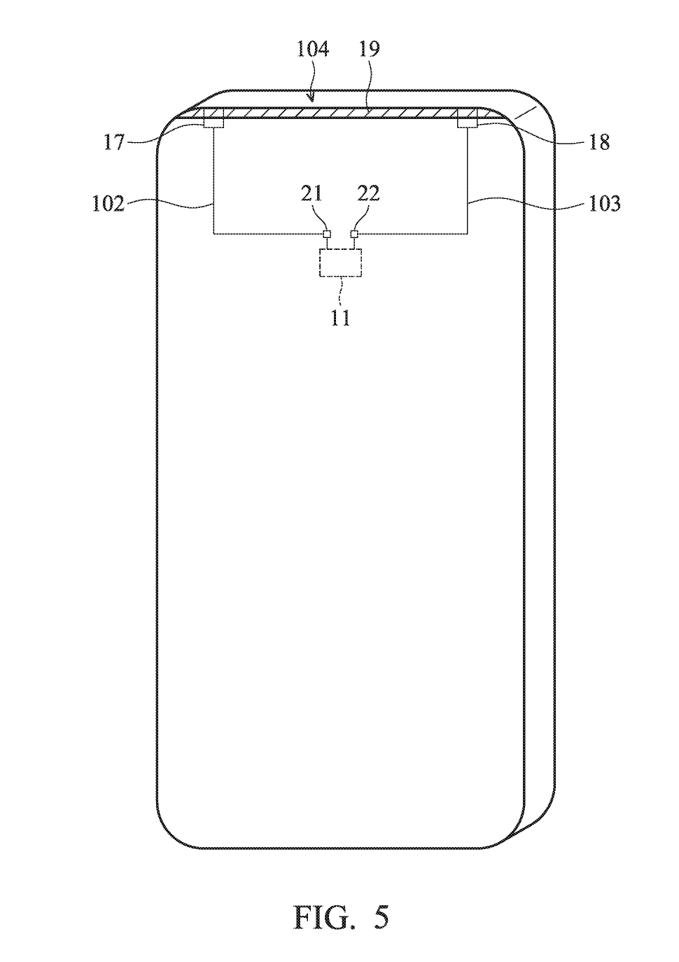

FIG. 5 shows an exemplary example of the hybrid-type NFC antenna 12 according to a fifth embodiment of the present disclosure. In the fifth embodiment, FIG. 5 shows a rear perspective view of the electronic device 10, wherein the electronic device 10 is a portable device such as a mobile phone. In the fifth embodiment, the radio frequency circuit 11 is integrated on a circuit board 13 (not shown) of the mobile phone, and two differential outputs of the radio frequency circuit 11 of the mobile phone are respectively electrically connected to two differential connection ports 21, 22 of the hybrid-type NFC antenna 12.

In the fifth embodiment, the first metal component 201 of the loop antenna device 20 is implemented by a top metal 104, wherein the top metal 104 is the top metal shell of the mobile phone. Comparing with the hybrid-type NFC antenna 12 shown in FIG. 4, the hybrid-type NFC antenna 12 of the fifth embodiment is designed according to another groove of the mobile phone. Therefore, as shown in FIG. 5, the top metal 104 is adjacent to a second groove 19 of the mobile phone and forms an area with conductive path 202 and 203 to overlap the second groove 19.

In the fifth embodiment, the first conductive path 202 of the loop antenna device 20 is implemented by an antenna terminal 17 which is contacted with the top metal 104 at left side and a first conductive trace 102, and the second conductive path 203 of the loop antenna device 20 is implemented by an antenna terminal 18 which is contacted with the top metal 104 at right side and a second conductive trace 103.

In the fifth embodiment, the first conductive trace 102 is arranged from the differential connection port 21 to the antenna terminal 17, wherein the first conductive trace 102 is arranged to route via PCB trace from the differential connection port 21 to the antenna terminal 17. In the fifth embodiment, the second conductive trace 103 is arranged from the differential connection port 22 to the antenna terminal 18, wherein the second conductive trace 103 is arranged to route via PCB trace from the differential connection port 22 to the antenna terminal 18.

In the fifth embodiment, the inductance of the loop antenna device 20 (i.e., the equivalent serial inductance of the first conductive trace 102, the second conductive trace 103, the top metal 104, the first pogo pin 14, the antenna terminal 17, the antenna terminal 18, and on board series inductors or short elements) is greater than 0.15 μH, but the present invention is not limited thereto. Because the hybrid-type NFC antenna 12 of the fifth embodiment also utilizes the present metal components or metal structures of the mobile phone, the additional space cost of the hybrid-type NFC antenna 12 can be thereby reduced.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,”“second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A hybrid-type near field communication (NFC) antenna utilized in an electronic device, wherein the hybrid-type NFC antenna comprises:
two differential connection ports, respectively coupled to two differential outputs of a radio frequency circuit of the electronic device; and
a loop antenna device connected between the two differential connection ports, wherein the loop antenna device comprises at least one first metal component, and an inductance of the loop antenna device is greater than a first inductance; and
wherein the at least one first metal component is a metal element or an antenna device of the electronic device.

2. The hybrid-type NFC antenna of claim 1, wherein the loop antenna device further comprises a first conductive path and a second conductive path; and
wherein the first conductive path is connected between one of the two differential connection ports and the at least one first metal component, and the second conductive path is connected between the other one of the two differential connection ports and the at least one first metal component.

3. The hybrid-type NFC antenna of claim 2, wherein the first conductive path or the second conductive path further comprise at least one second metal component; and
wherein the at least one second metal component comprises inductors, flexible printed circuit (FPC) trace, printed circuit board (PCB) trace, metal wire, metal pierce, pogo pins, antenna terminals, or soldering iron.

4. The hybrid-type NFC antenna of claim 1, wherein the at least one first metal component comprises a conductive housing element, a display shielding metal, a metal foil, an electroplating conductive material, a PCB metal, an FPC metal, a slip, or a slot.

5. The hybrid-type NFC antenna of claim 1, wherein the at least one first metal component comprises far field type antennas, near field type antennas, or inductors.

6. An electronic device, comprising:
a radio frequency circuit; and
a hybrid-type near field communication (NFC) antenna, comprising:
two differential connection ports, respectively coupled to two differential outputs of the radio frequency circuit; and
a loop antenna device connected between the two differential connection ports, wherein the loop antenna device comprises at least one first metal component and an inductance of the loop antenna device is greater than a first inductance; and
wherein the at least one first metal component is a metal element or an antenna device of the electronic device.

7. The electronic device of claim 6, wherein the loop antenna device further comprises a first conductive path and a second conductive path; and
wherein the first conductive path is connected between one of the two differential connection ports and the at least one first metal component, and the second conductive path is connected between the other one of the two differential connection ports and the at least one first metal components.

8. The electronic device of claim 7, wherein the first conductive path or the second conductive path further comprise at least one second metal component; and
wherein the at least one second metal component comprises inductors, flexible printed circuit (FPC) trace, printed circuit board (PCB) trace, metal wire, metal pierce, pogo pins, antenna terminals, or soldering iron.

9. The electronic device of claim 6, wherein the at least one first metal component comprises a conductive housing element, a display shielding metal, a metal foil, an electroplating conductive material, a PCB metal, an FPC metal, a slip, or a slot.

10. The electronic device of claim 6, wherein the at least one first metal component comprises far field type antennas, near field type antennas, or inductors.
